(19) United States
(12) Patent Application Publication
(10) Pub. No.: US 2016/0348871 A1
(43) Pub. Date: Dec. 1, 2016

(54) ARTIFICIAL ICICLES

(71) Applicant: Holly HARRIS, Roseville, CA (US)

(72) Inventor: Holly HARRIS, Roseville, CA (US)

(21) Appl. No.: 15/137,462

(22) Filed: Apr. 25, 2016

Related U.S. Application Data
(60) Provisional application No. 62/168,097, filed on May 29, 2015.

(51) Int. Cl. F21V 3/04; F21S 4/10

(52) U.S. Cl. CPC F21V 3/049; F21S 4/10; F21W 2121/006

(57) ABSTRACT

Embodiments described herein advantageously provide an artificial multi-icicle structure. In one embodiment, the structure includes a base from which a plurality of icicles extend to imitate a multi-pendant mass of ice formed by the freezing of dripping water. The plurality of icicles are elongated along a length of the structure so that at least some of the lengths exceed about one fifth a length of the structure. The lengths of the icicles are staggered to be of different lengths. The icicles terminate in spaced apart conical ends. The icicles are cascaded so that different icicles start at different positions along the length of the structure.

### CROSS-REFERENCE TO RELATED APPLICATION

This application is related to and claims priority to U.S. Provisional Patent Application Ser. No.: 62/168,097, filed May 29, 2015, entitled “ARTIFICIAL ICICLES”, the entirety of which is incorporated herein by reference.

### TECHNICAL FIELD

The present invention relates to artificial icicles.

### BACKGROUND

In winter time many people prefer to decorate their home with light strands 10 such as shown in FIG. 1 which coarsely imitate icicles hanging from the eaves of a roof of the home. Attempts have been made to provide artificial icicles that can be lighted, such as the structure disclosed in U.S. Pat. No. 6,811,283, which shows an individual single-pendant icicle in which an electric light is disposed. U.S. Pat. No. 8,622,576 shows a string of single-pendant icicle shaped light bulbs with an irregular rough surface. U.S. Design Pat. No. D576,070 shows a multifaceted single-pendant icicle with a globular surface. U.S. Pat. No. 3,302,013 shows a dual-pendant icicle structure having icicles of equal length. U.S. Pat. No. 3,704,365 shows a multi-pendant hollow icicle structure where the individual icicles all start from the base and are of unequal length. Some disadvantages of these devices and designs include difficulty of manufacture and assembly, cost, and lack of aesthetic qualities. Further, they do not look much like actual icicles that form in nature, and do not integrate well with existing decorative lights.

### SUMMARY

Embodiments described herein advantageously provide an artificial multi-icicle structure. In one embodiment, the structure includes a base from which a plurality of icicles extend to imitate a multi-pendant mass of ice formed by the freezing of dripping water. The plurality of icicles are elongated along a length of the structure so that at least some of the lengths exceed about one fifth a length of the structure. The lengths of the icicles are staggered to be of different lengths. The icicles terminate in spaced apart conical ends. The icicles are cascaded so that different icicles start at different positions along the length of the structure.

According to another aspect, some embodiments provide an icicle light structure having an array of hanging icicle lights. Attached to the array of hanging icicle lights is an array of unitary icicle structures. Each one of the unitary icicle structures includes a plurality of icicles extending from a common base to imitate a multi-pendant mass of ice formed by the freezing of dripping water. The plurality of icicles are elongated along a length of the structure so that at least some of the lengths exceed about one fifth a length of the structure. The lengths of the icicles are staggered. The icicles terminate in spaced apart conical ends. Further, the icicles are cascaded so that different icicles start at different positions along the length of the structure.

According to another aspect, some embodiments provide a cluster of cascaded icicle-shaped pendants adapted to be attached to another cluster of icicle shaped pendants. The icicle-shaped pendants each start and end at separate points of the icicle decoration, each icicle-shaped pendant being substantially conical near an end. In some embodiments, the icicles can be attached to a structure by clips. Thus, the icicles may be attached to hanging icicle lights or attached to a gutter. In some embodiments, the icicles may be hanged from a structure using clips especially adapted for this purpose.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a strand of icicle lights;

FIG. 2 shows an embodiment of multi-pendant icicle structures;

FIG. 3 shows an embodiment of multi-pendant icicle structures;

FIG. 4 shows an embodiment of multi-pendant icicle structures;

FIG. 5 shows an embodiment of multi-pendant icicle structures;

FIG. 6 shows an embodiment of multi-pendant icicle structures;

FIG. 7 show a plurality of multi-pendant icicle structures attached to a string of light strands;

FIG. 8 shows an embodiment of multi-pendant icicle structures;

FIG. 9 shows an embodiment of multi-pendant icicle structures;

FIG. 10 shows an embodiment of multi-pendant icicle structures;

FIG. 11 shows an embodiment of multi-pendant icicle structures;

FIG. 12A shows an embodiment of clip;

FIG. 12B shows an embodiment of a clip;

FIG. 12C shows an embodiment of a clip; and

FIG. 12D shows an embodiment of a clip.

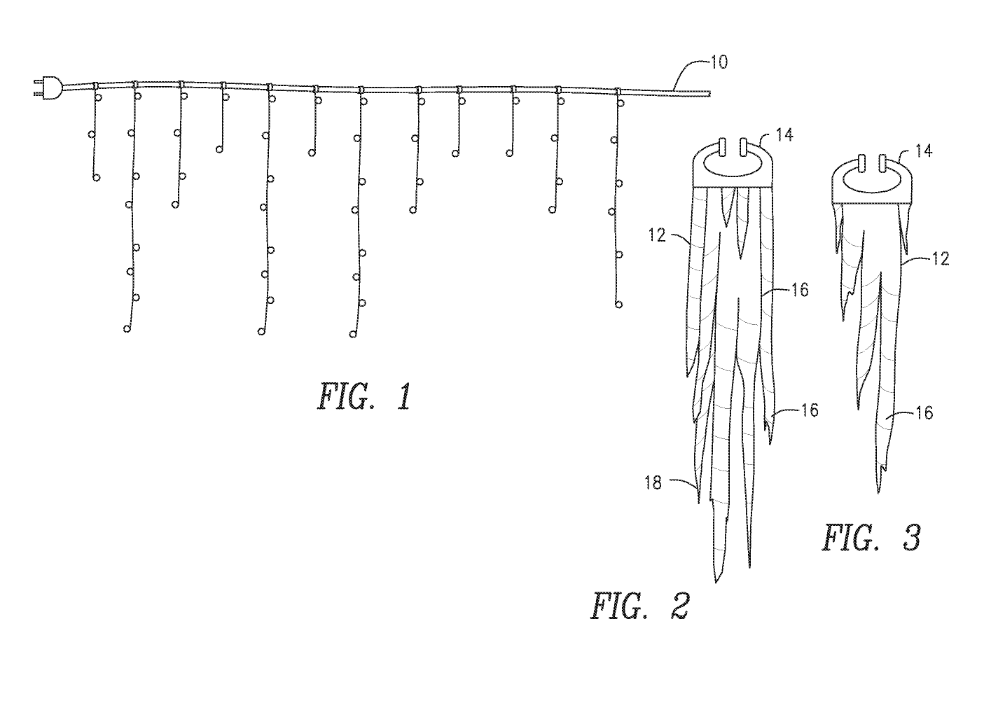

### DETAILED DESCRIPTION

Before describing in detail example embodiments that are in accordance with the present disclosure, it is noted that the embodiments reside primarily in artificial icicle structures. Accordingly, the artificial icicle structures have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

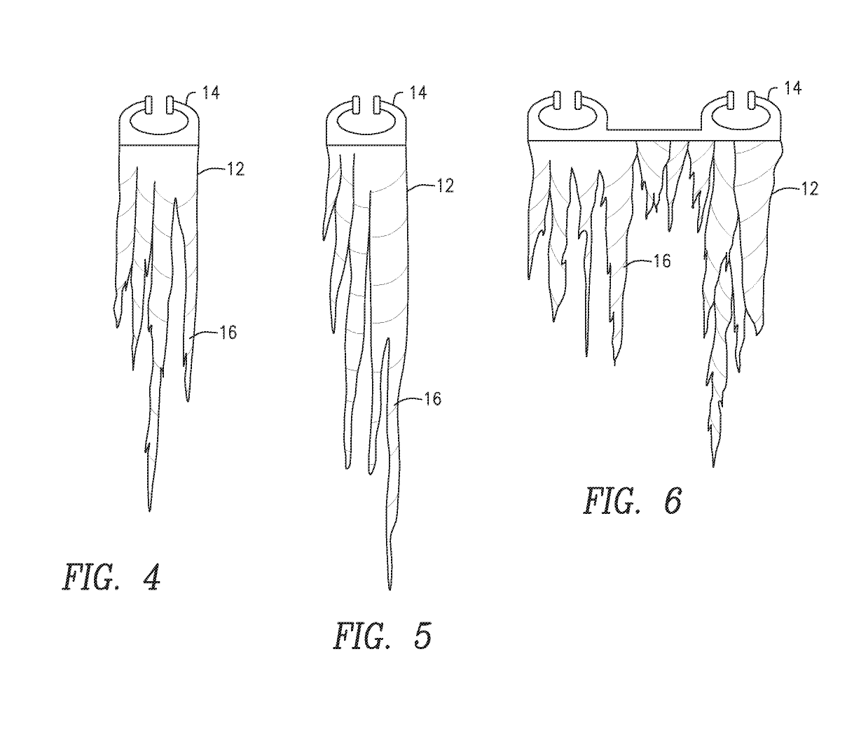

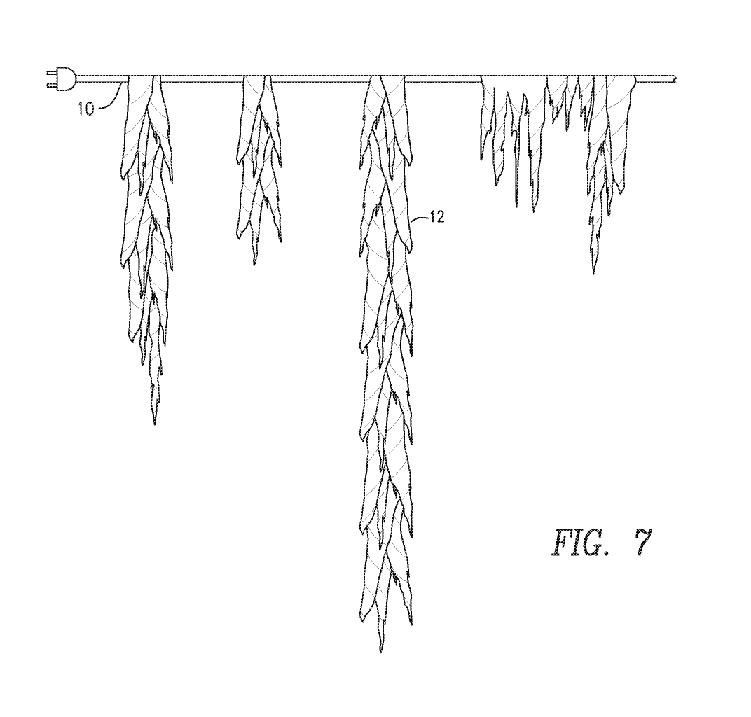

FIGS. 2-6, show different embodiments of multi-pendant icicle structures that can be used with light strands 10. Each embodiment of these figures is a cluster of cascaded icicles forming an icicle structure 12 having clips or fasteners 14 to secure the icicle structure 12 to eaves or light strands 10. Each icicle structure 12 has icicle pendants 16 that start at different points along the length of the multi-pendant icicle structure 12. In some embodiments, such as the embodiment of FIG. 2, one multi-pendant icicle structure 18 can be attached by clips or fasteners (not shown) near a distal end of another multi-pendant icicle structure 12 to increase a length of the icicle structure. In some embodiments, the fasteners or clips are hidden from view. In some embodiments, pendants in the foreground partially obscure pendants in the background. The multi-pendant icicle structures 12 may be attached to eaves of a roof, to a gutter around the perimeter of the roof, or directly to the light strands 10 as shown in FIG. 7. The icicles of the icicle structures 12 may be translucent or opaque, and may be of different colors. When the icicle structures 12 are translucent, the light of the light strands 10 passes through the icicles 16 along the length of the icicles 16.

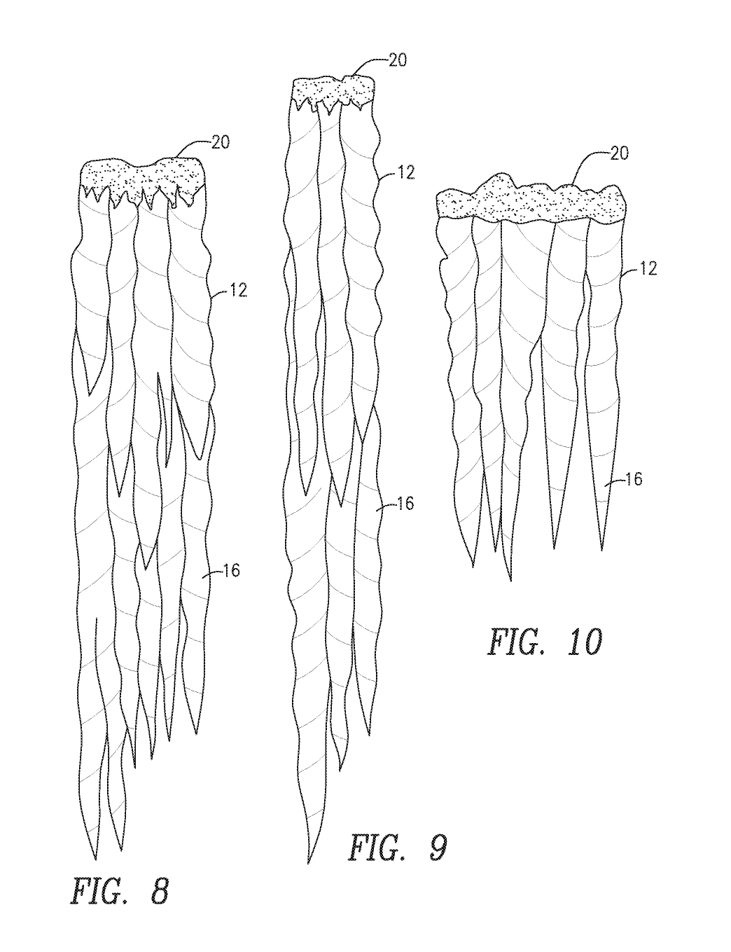

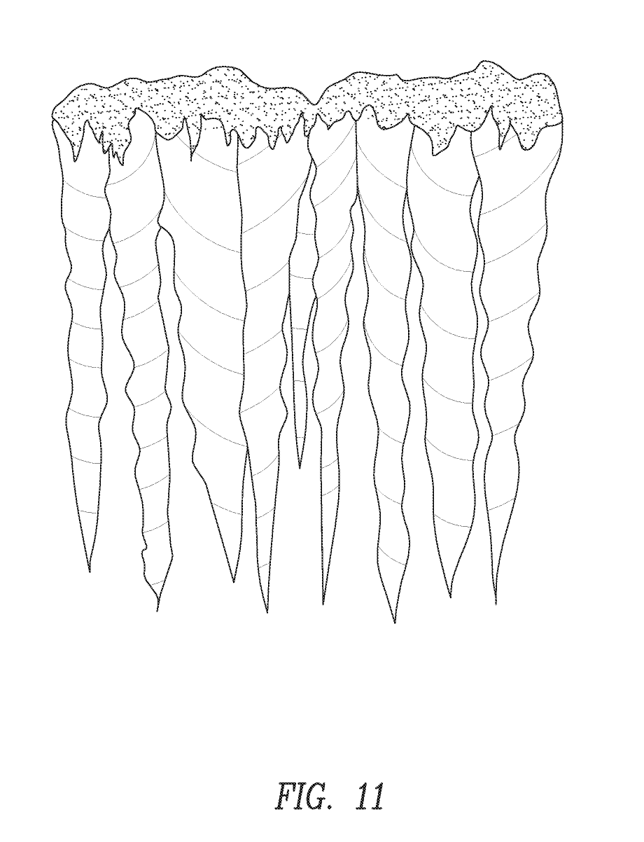

FIGS. 8-11 show some embodiments of artificial icicle structures constructed in accordance with principles disclosed herein. These embodiments show unitary artificial multi-icicle structures 12 that have a base 20 which may be frosted at least at the base, in some embodiments. Extending from the base in one unitary piece are icicles 16 that imitate a multi-pendant mass of ice formed by the freezing of dripping water. The plurality of icicles 16 are elongated along a length of the structure 12 so that at least some of the lengths of the icicles 16 exceed about one fifth a length of the structure 12 to achieve a more realistic appearance. In some embodiments the pendants of the icicles exhibit a spiral contour.

The lengths of each icicle 16 forming the structure 12 may be staggered and terminated in spaced apart conical ends. In some embodiments, the icicles 16 are cascaded so that different icicles start at different points of the structure 12. In some embodiments, the icicles 16 overlap so that some icicles in a background are partially obscured by icicles in a foreground. Some of the icicles in the background are longer than about a fifth of a length of the structure. In some embodiments, the structure 12 has a depth of at least 3 icicles 16. In some embodiments, the icicle structures 12 are 3-dimensional, i.e., having volume. In some embodiments, the volume is solid, having no hollowed-out chamber. In some embodiments, the icicle structures 12 are substantially 2-dimensional, i.e., flat. In some embodiments, the icicle structures 12 appear substantially the same when viewed from a front or back of the icicle structures 12. In some embodiments, the icicle structures 12 are rigid, whereas in other embodiments, the icicle structures are flexible. In some embodiments, the icicles may have jagged edges. In some embodiments, the icicles may be formed from a mold.

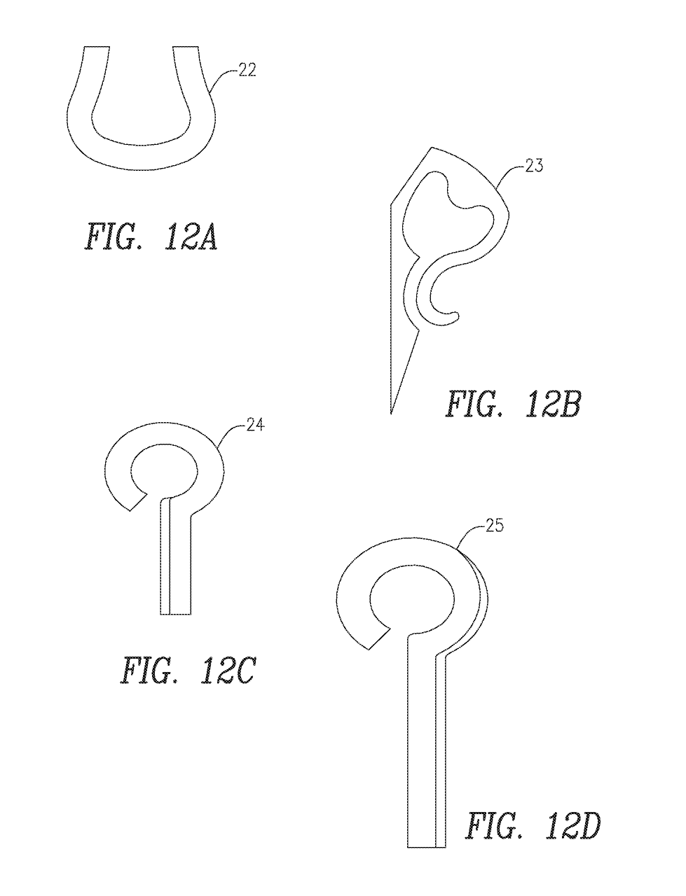

FIGS. 12A, 12B, 12C and 12D illustrate various clips 22-25 for attaching the icicles 12. A first embodiment of a clip for attached icicles 12 is clip 22 which may be attached, by adhesive, for example, to a base of the icicles. Another clip 23 is configured to attach an icicle to a gutter. Another clip 24 is configured to hang an icicle. Another clip 25 is configured to hang longer or larger icicles.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A unitary artificial multi-icicle structure, comprising;
a base from which a plurality of icicles extend in one unitary piece to imitate a multi-pendant mass of ice formed by the freezing of dripping water, the plurality of icicles being elongated along a length of the structure so that at least some of the lengths exceed about one fifth a length of the structure, the lengths of the icicles being staggered, the icicles terminating in spaced apart conical ends, the icicles being cascaded so that different icicles start at different positions along the length of the structure.

2. The structure of claim 1, wherein a plurality of icicles overlap, thereby at least partially obscuring a portion of icicles in a background by icicles in a forefront.

3. The structure of claim 2, wherein at least some of the icicles in the background are longer than about one fifth a length of the structure.

4. The structure of claim 1, wherein the base is frosted.

5. The structure of claim 1, wherein the structure is of a depth of at least 3 icicles.

6. The structure of claim 1, wherein the structure is translucent and adapted to hang in front of icicle lights.

7. The structure of claim 6, further comprising fasteners at the base to fasten the structure to the icicle lights.

8. The structure of claim 1, further comprising fasteners at the base to fasten the structure to a supporting object.

9. The structure of claim 1, wherein at least some icicles have jagged edges.

10. An icicle light structure, comprising:
an array of hanging icicle lights;
attached to the array of hanging icicle lights, an array of unitary icicle structures, each one of the unitary icicle structures including a plurality of icicles extending from a common base to emulate a multi-pendant mass of ice formed by the freezing of dripping water, the plurality of icicles being elongated along a length of the structure so that at least some of the lengths exceed about one fifth a length of the structure, the lengths of the icicles being staggered, the icicles terminating in spaced apart conical ends, the icicles being cascaded so that different icicles start at different positions along the length of the structure.

11. The structure of claim 10, wherein a plurality of icicles of a unitary icicle structure overlap, thereby obscuring a portion of icicles in a background by icicles in a forefront.

12. The structure of claim 11, wherein at least some of the icicles in the background are longer than about one fifth a length of a unitary icicle structure.

13. The structure of claim 10, wherein a unitary icicle structure is of a depth of at least 3 icicles.

14. The structure of claim 10, wherein the unitary icicle structures are attached to the hanging lights via of a fastener that is hidden from a front view of the icicle light structure.

15. The structure of claim 10, wherein the unitary icicle structures are not hollow.

16. An icicle decoration adapted for hanging to a structure, the icicle decoration comprising:
a cluster of cascaded icicle-shaped pendants adapted to be attached by at least one clip to one of a structure and another cluster of icicle shaped pendants, the icicle-shaped pendants each starting and ending at separate points of the icicle decoration, each icicle-shaped pendant being substantially conical near an end.

17. The icicle decoration of claim 16, wherein some of the icicle shaped pendants in the cluster are of substantially different lengths.

18. The icicle decoration of claim 16, wherein the icicle shaped pendants are 3-dimensional.

19. The icicle decoration of claim 16, wherein a plurality of icicles shaped pendants overlap, thereby obscuring a portion of icicles in a background by icicles in a forefront.

20. The icicle decoration of claim 16, wherein the plurality of icicle shaped pendants are translucent.
